(19) United States
(12) Patent Application Publication
(10) Pub. No.: US 2008/0178839 A1
(43) Pub. Date: Jul. 31, 2008

(54) Idling engine speed control system for a vehicle and vehicle equipped with idling engine speed control system

(75) Inventors: Takeru Oshima, Kobe-shi (JP); Satoru Sakanaka, Akashi-shi (JP); Takuya Sakamoto, Akashi-shi (JP); Tatsuya Hirokami, Osaka-shi (JP)

Correspondence Address: ALLEMAN HALL MCCOY RUSSELL & TUTTLE LLP, 806 SW BROADWAY, SUITE 600, PORTLAND, OR, 97205-3335, US

(73) Assignee: Kawasaki Jukogyo Kabushiki Kaisha, Kobe-shi (JP)

(21) Appl. No.: 12/011,695

(22) Filed: Jan. 28, 2008

(30) Foreign Application Priority Data
Jan. 29, 2007 (JP) 2007-017492

(51) Int. Cl. F02M 3/07; F02D 31/00; F02D 41/08

(52) U.S. Cl. 123/339.2; 123/339.22; 123/339.13; 123/339.11; 123/339.12

(57) ABSTRACT

An idling engine speed control system for a vehicle comprises a valve which is provided within an air-intake passage connected to an engine mounted in the vehicle and is configured to substantially open and close the air-intake passage, a drive device configured to open and close the valve, an opening degree controller configured to drive the drive device and is configured to control an opening degree of the air-intake passage, an input device which is attached to the vehicle and is configured to input a target engine speed in an idling state, and an engine speed memory configured to store the target engine speed input with the input device, wherein the opening degree controller is configured to control the opening degree of the air-intake passage in an idling state according to the target engine speed stored in the engine speed memory.

### TECHNICAL FIELD

The present invention relates to an idling engine speed control system configured to control an engine speed in an idling state of a vehicle, and a vehicle equipped with such an idling engine speed control system.

### BACKGROUND ART

In motorcycles and automobiles, engine speeds in an idling state (hereinafter referred to as an idling engine speed) are set by manufacturers, and therefore, users cannot change the set engine speeds. But, the user sometimes has a demand to change the idling engine speeds according to the type of vehicle, the use of the vehicle, the user's taste or preference, etc. For example, some users have a desire to set the idling engine speed higher in sport-type motorcycles, and others have a desire to set the idling engine speed lower in cruiser-type motorcycles.

One prior art idling engine speed control system is coupled to an engine, and has an air-intake passage which is substantially opened and closed by a throttle valve provided therein, and a bypass passage connecting to each other a region of the air-intake passage located upstream of the throttle valve and a region of the air-intake passage located downstream of the throttle valve. An air adjust screw is provided in the bypass passage to be able to adjust a flow rate of air flowing in the bypass passage, thereby changing the idling engine speed (see Japanese Laid-Open Patent Application Publication No. Hei. 6-167264, and Japanese Patent No. 3713775).

In the above described idling engine speed control system, the air adjust screw is hand-operated to adjust the flow rate of the air flowing in the bypass passage, enabling the idling engine speed to be controlled. The air adjust screw is of a mechanical type, and therefore is required to be hand-operated. The hand operation of the air adjust screw to increase or decrease the idling engine speed is relatively easy. However, since the flow rate of the air flowing in the bypass passage is adjusted by the hand operation of the air adjust screw, and the engine speed can fluctuate because of environmental changes such as temperature change and atmospheric-pressure change, it can be difficult to control the engine speed according to the type or use of the vehicle, the user's taste or preference, etc.

### SUMMARY OF THE INVENTION

The present invention addresses the above described conditions, and an object of the present invention is to provide an idling engine speed control system capable of changing an idling engine speed according to a user's taste or preference, a use of a vehicle, etc., by operating an input device attached to the vehicle, and a vehicle equipped therewith.

According to an aspect of the present invention, there is provided an idling engine speed control system for a vehicle comprising a valve which is provided within an air-intake passage connected to an engine mounted in the vehicle and is configured to substantially open and close the air-intake passage; a drive device configured to open and close the valve; an opening degree controller configured to drive the drive device and is configured to control an opening degree of the air-intake passage; an input device which is attached to the vehicle and is configured to receive a target engine speed input in an idling state; and an engine speed memory configured to store the target engine speed input with the input device; wherein the opening degree controller is configured to control the opening degree of the air-intake passage in the idling state according to the target engine speed stored in the engine speed memory.

In such a configuration, when the user inputs the target engine speed with the input device attached to the vehicle, the opening degree controller drives the valve to control the opening degree of the air-intake passage in the idling state, according to the input target engine speed. This makes it possible to change the idling engine speed to a desired engine speed according to the target engine speed input by the user. The user is able to easily change the engine speed in the idling state by merely operating the input device, and thus to change the engine speed in the idling state according to the user's taste or preference, use of the vehicle, etc.

The idling engine speed control system may further comprise a mode controller configured to execute switching between an idling engine speed control mode in which the target engine speed is able to be input with the input device and a normal mode in which the target engine speed is unable to be input with the input device. The input device is configured to execute a switching operation for switching between the idling engine speed control mode and the normal mode. The mode controller may be configured to execute switching between the idling engine speed control mode and the normal mode based on the switching operation executed by the input device.

In such a configuration, the mode controller switches the normal mode to the idling engine speed control mode upon the switching operation being executed with the input device in the normal mode. When the user inputs the target engine speed with the input device in the idling engine speed control mode, the opening degree controller controls the opening degree of the air-intake passage in the idling state to change the idling engine speed according to the input target engine speed. Also, the mode controller switches the idling engine speed to the normal mode when the switching operation is executed by the input device in the idling engine speed control mode. In the normal mode, the target engine speed is unable to be input with the input device, and thus, the idling engine speed is inhibited from being changed to an undesired value. This makes it possible to avoid the idling engine speed being changed against the user's will.

The input device may be attached to a meter device which is mounted to the vehicle and is configured to display an engine speed of the engine.

In such a configuration, since the input device is attached to the meter device configured to display the engine speed, the user inputs the target engine speed with the input device to control the idling engine speed while checking the engine speed displayed on the meter device. Thereby, the user is able to control the idling engine speed with the input device while checking the engine speed. Thus, the user is able to easily set the idling engine speed.

The idling engine speed control system may further comprise a temperature meter configured to measure a temperature of the engine. The mode controller may be configured to enable switching to the idling engine speed control mode based on the switching operation, when the temperature of the engine which is measured by the temperature meter is a predetermined value or higher.

The idling engine speed control system may further comprise an opening degree detector configured to detect an opening degree of a throttle grip mounted to the vehicle. The mode controller may be configured to enable switching to the idling engine speed control mode based on the switching operation, when the opening degree detected by the opening degree detector is not more than a predetermined reference value used for determining whether or not the throttle grip is in a closed state.

The idling engine speed control system may further comprise a gear position detector configured to detect a gear position of a transmission disposed between an output shaft of the engine and a wheel of the vehicle. The mode controller may be configured to enable switching to the idling engine speed control mode based on the switching operation, when the gear position detected by the gear position detector is a neutral position.

The idling engine speed control system may further comprise an engine running detector configured to detect whether or not the engine is running. The mode controller may be configured to enable switching to the idling engine speed control mode based on the switching operation, when the engine running detector has detected that the engine is running.

The idling engine speed control system may further comprise a vehicle speed detector configured to detect a vehicle speed of the vehicle. The mode controller may be configured to enable switching to the idling engine speed control mode based on the switching operation, when the vehicle speed detected by the vehicle speed detector is not higher than a predetermined value used for determining whether or not the vehicle is in a stopped state.

The input device may have two push-button switches, and may be configured to increase the target engine speed stored in the engine speed memory by a predetermined value each time one of the push-button switches is pressed and to decrease the target engine speed stored in the engine speed memory by a predetermined value each time the other of the push-button switches is pressed..

The two push-button switches may be configured to enable the switching operation for pressing the two push-button switches substantially at the same time.

In such a configuration, by pressing the two switches at the same time, switching to the idling engine speed control mode is executed. In the idling engine speed control mode, when one of the switches of the input device is pressed once, the target engine speed stored in the engine speed memory is increased by a predetermined value, while when the other switch is pressed once, the target engine speed stored in the engine speed memory may be decreased by a predetermined value. Since the switches mounted to the vehicle are used for switching between the normal mode and the idling engine speed control mode and for increasing and decreasing the target engine speed in the idling engine speed control mode, additional switches may not be necessary. As a result, the number of components may be reduced, and the configuration of the idling engine speed control system may be simplified.

The input device may have first to third push-button switches. The first switch may be configured to enable the switching operation. The second switch may be configured to increase the target engine speed stored in the engine speed memory by a predetermined value each time the second switch is pressed. The third switch may be configured to decrease the target engine speed stored in the engine speed memory by a predetermined value each time the third switch is pressed.

The opening degree controller may be configured, when the target engine speed is input with the input device to change the target engine speed in the idling state of the engine, to control the opening degree of the air-intake passage in the idling state according to the changed target engine speed.

Also, the user is able to change the target engine speed while hearing an engine noise or a gas exhausting noise.

The idling engine speed control system may further comprise an engine speed meter configured to measure an engine speed of the engine. The opening degree controller may be configured to, based on an engine speed of the engine in the idling state, which is measured by the engine speed meter, control the opening degree of the air-intake passage in the idling state so that the engine speed in the idling state conforms to the target engine speed. In such a configuration, the engine speed in the idling state can be controlled to reach the target engine speed.

The idling engine speed control system may further comprise a mode controller configured to switch an idling engine speed control mode in which the target engine speed is able to be input with the input device and a normal mode in which the target engine speed is unable to be input with the input device; an engine running detector configured to detect whether or not the engine is running; a temperature meter configured to measure a temperature of the engine; an opening degree detector configured to detect an opening degree of the throttle grip; and a gear position detector configured to detect a gear position of a transmission disposed between an output shaft of the engine and a wheel of the vehicle; and the input device may be configured to enable a switching operation for switching between the idling engine speed control mode and the normal mode. The mode controller may be configured to enable switching to the idling engine speed control mode based on the switching operation, when a first condition in which the temperature measured by the temperature meter is a predetermined temperature or higher, a second condition in which the opening degree detected by the opening degree detector is not more than a predetermined reference value used for determining whether or not the throttle grip is in a closed state, a third condition in which the gear position detected by the gear position detector is a neutral position, and a fourth condition in which the engine running detector detects that the engine is running are all met.

The idling engine speed control system may further comprise an ignition device configured to ignite an air-fuel mixture in a combustion chamber of the engine; and the opening degree controller may be configured to control an ignition timing of the ignition device in the idling state according to the target engine speed.

In such a configuration, the opening degree controller is configured to control the opening degree of the air-intake passage and the ignition timing of the ignition device in the idling state, according to the input target engine speed. This makes it possible to change the idling engine speed to a desired engine speed according to the input target engine speed.

The idling engine speed control system may further comprise an fuel injector configured to inject a fuel to inside of the air-intake passage. The opening degree controller may be configured to control an amount of the fuel injected from the fuel injector in the idling state according to the target engine speed.

In such a configuration, the opening degree controller is configured to control the opening degree of the air-intake passage and the fuel injection amount of the fuel injector in the idling state, according to the input target engine speed. This makes it possible to change the idling engine speed to a desired engine speed according to the input target engine speed.

According to another aspect of the present invention, there is provided an idling engine speed control system for a vehicle, comprising a valve which is provided within an air-intake passage connected to an engine mounted in the vehicle and is configured to substantially open and close the air-intake passage; a drive device configured to open and close the valve; an ignition device configured to ignite an air-fuel mixture in a combustion chamber of the engine; a fuel injector configured to inject a fuel to inside of the air-intake passage; an opening degree controller configured to drive the drive device to control an opening degree of the air-intake passage and to control an ignition timing of the ignition device and an amount of the fuel injected from the fuel injector; an input device which is attached to the vehicle and is configured to input a target engine speed in an idling state to change the target engine speed; and an engine speed memory configured to store the target engine speed input with the input device; wherein the opening degree controller is configured to control the opening degree of the air-intake passage, the ignition timing and the amount of the fuel injected from the fuel injector in the idling state, according to the target engine speed stored in the engine speed memory.

In such a configuration, when the user inputs the target engine speed with the input device attached to the vehicle, the opening degree controller controls the opening degree of the air-intake passage, the ignition timing and the fuel injection amount in the idling state, according to the input target engine speed. By merely operating the input device, the user is able to easily change the idling engine speed, according to the user's taste or preference, use of the vehicle, etc.

According to another aspect of the present invention, there is provided a vehicle comprising an idling engine speed control system, the idling engine speed control system including a valve which is provided within an air-intake passage connected to an engine mounted in the vehicle and is configured to substantially open and close the air-intake passage; a drive device configured to open and close the valve; an opening degree controller configured to drive the drive device and is configured to control an opening degree of the air-intake passage; an input device which is attached to the vehicle and is configured to input a target engine speed in an idling state; and an engine speed memory configured to store the target engine speed input with the input device; wherein the opening degree controller is configured to control the opening degree of the air-intake passage in the idling state according to the target engine speed stored in the engine speed memory.

In such a configuration, it is possible to provide a vehicle which is able to control the idling engine speed.

The above and further objects and features of the invention will more fully be apparent from the following detailed description with accompanying drawings.

### BRIEF DESCRIPTION OF THE DRAWINGS

FIG. 1 is a side view of a motorcycle equipped with an idling engine speed control system according to an embodiment of the present invention;

FIG. 2 is a block diagram showing a configuration of the idling engine speed control system of FIG. 1;

FIG. 3 is a plan view of a meter device attached to a vehicle body of the motorcycle of FIG. 1;

FIG. 4 is a flowchart showing an idling control process for changing an engine speed in an idling state;

FIG. 5 is a view showing a time-lapse change of a signal transmitted between an engine control unit (ECU) and a meter controller;

FIG. 6 is a block diagram showing transmission of the signal between the ECU and the meter controller; and

FIG. 7 is a plan view showing another embodiment of the meter device.

### DETAILED DESCRIPTION OF THE PREFERRED EMBODIMENT

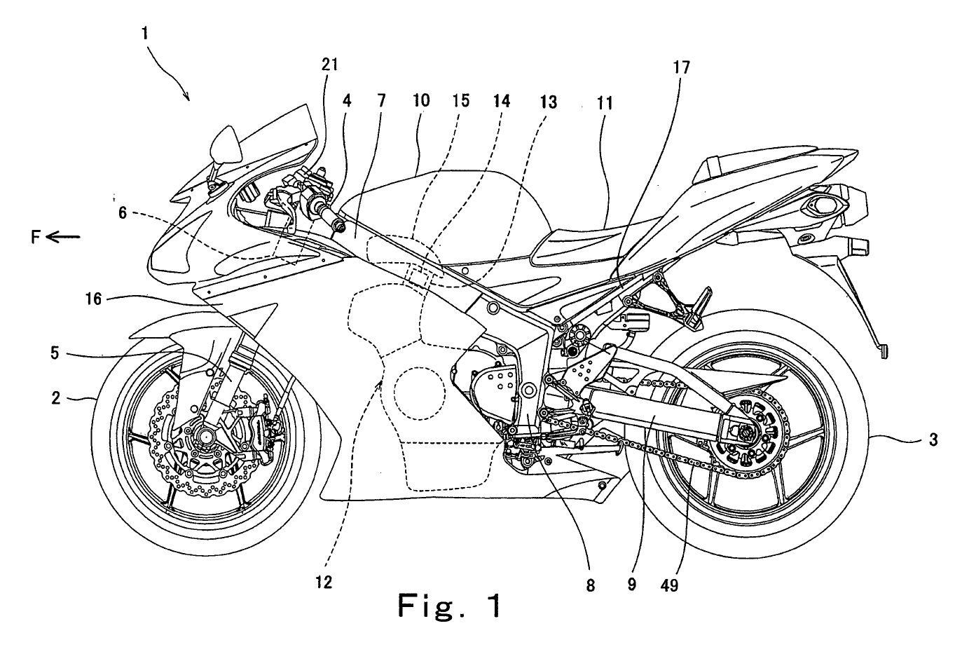

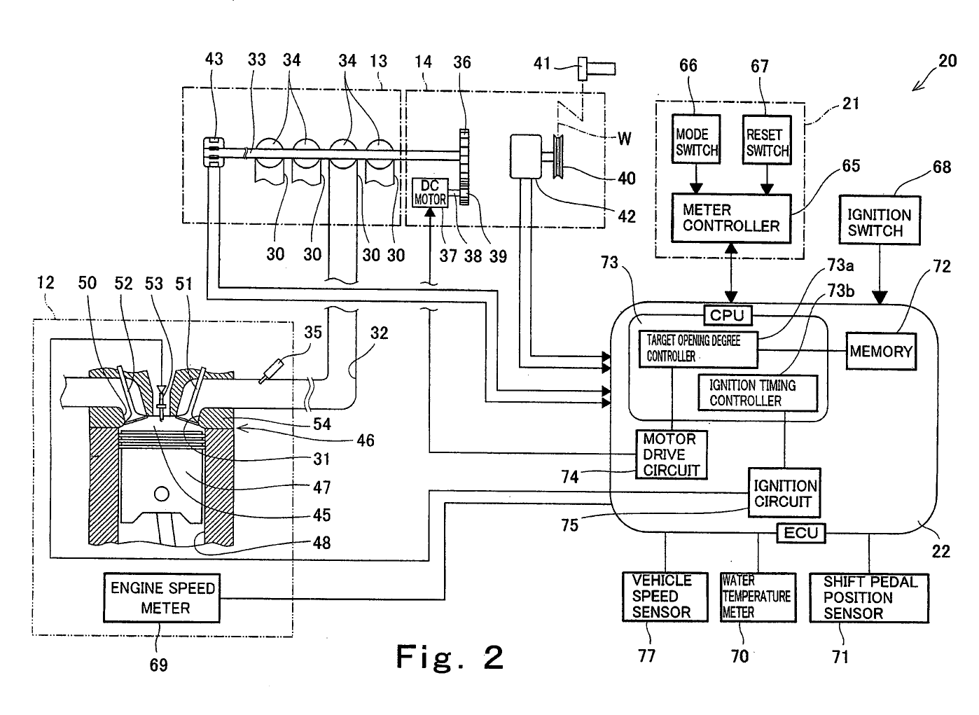

Hereinafter, an embodiment of the present invention will be described with reference to the accompanying drawings. FIG. 1 is a side view of a motorcycle 1 equipped with an idling engine speed control system 20 according to the embodiment of the present invention. Turning now to FIG. 1, the motorcycle 1 is of a sport-type motorcycle straddled by a user (not shown) whose upper body is bent forward. Herein, directions are generally referenced from the perspective of the user, to be precise, a driver mounting the motorcycle 1 of FIG. 1. To be specific, leftward in FIG. 1 is forward F, rightward in FIG. 2 is rearward, and a depth direction in FIG. 1 is rightward and leftward. The motorcycle 1 is equipped with an electronic throttle valve (ETV) system in which an engine control unit (ECU) controls a throttle valve 34 based an opening degree of a throttle grip 41 to thereby control an amount of air supplied to an engine 12. In this embodiment, the engine 12 is an in-line four-cylinder engine. A detailed construction of the motorcycle 1 will now be described with reference to FIG. 1.

As shown in FIG. 1, the motorcycle 1 includes a front wheel 2 and a rear wheel 3. The front wheel 2 is rotatably mounted to a lower end portion of a front fork 5 extending substantially vertically. The front fork 5 is mounted on a steering shaft (not shown) by an upper bracket (not shown) attached to an upper end thereof, and an under bracket (not shown) located under the upper bracket. The steering shaft is rotatably supported by a head pipe 6. A bar-type steering handle 4 extending rightward and leftward is attached to the upper bracket. When the user rotates the steering handle 4 clockwise or counterclockwise around the steering shaft, the front wheel 2 is turned to a desired direction. A meter device 21 for displaying a vehicle speed of the motorcycle 1, an engine speed of the engine 12, etc., is provided in front of the steering handle 4 so as to be located substantially above the steering shaft of the front wheel 2.

A pair of right and left main frame members 7 extend rearward from the head pipe 6 to be tilted slightly downward. A pair of right and left pivot frame members 8 are coupled to rear portions of the main frame members 7. A swing arm 9 is pivotally mounted at a front end portion thereof to each of the pivot frame members 8 and is configured to extend substantially in a longitudinal direction of a vehicle body of the motorcycle 1. The rear wheel 3, which is a drive wheel, is rotatably mounted on a rear end portion of the swing arm 9. A fuel tank 10 is disposed behind the steering handle 4 and is mounted on the main frame members 7. A straddle-type seat 11 is disposed behind the fuel tank 10 and is mounted on the main frame members 7, rear frame members 17, and others.

Between the front wheel 2 and the rear wheel 3, the engine 12 is mounted on the main frame members 7, the pivot frame members 8, and others. A throttle device 13 is disposed inward of the main frame members 7 and has four air-intake passages 32 coupled to intake ports 31 (see FIG. 2) of the engine 12. A muffler (not shown), which is an exhaust device, is coupled to exhaust ports 50 (FIG. 2) of the engine 12. The throttle device 13 has a throttle valve 34 (FIG. 2) configured to substantially open and close the corresponding air-intake passage 32. The throttle device 13 is provided with a throttle valve opening and closing device 14 configured to open and close the throttle valve 34 (FIG. 2). An air cleaner box 15 is disposed below the fuel tank 10 and is coupled to an upstream side of the air-intake passages 32 (FIG. 2) of the throttle device 13. The air cleaner box 15 is configured to take in fresh air from outside by utilizing a wind pressure (ram pressure) of the wind blowing from forward. A cowling 16 extends from a front portion of the vehicle body to side portions of the vehicle body so as to cover the engine 12 and other components. An ECU (engine control unit) 22 (FIG. 2) is built into the motorcycle 1 and is configured to electronically control components of the motorcycle 1.

FIG. 2 is a block diagram showing a configuration of the idling engine speed control system 20. With reference to FIGS. 1 and 2, the idling engine speed control system 20 will be described. The idling engine speed control system 20 includes the throttle device 13, the throttle valve opening and closing device 14, the engine 12, the meter device 21, and the ECU 22. The throttle device 13 has a throttle body including a plurality of, for example, four, air-intake tubular portions 30 arranged in-line. An upstream opening of the air-intake tubular portion 30, which is located on an upstream side in a flow direction of air taken in from outside, is coupled to the air cleaner box 15, and a downstream opening thereof is coupled to the corresponding intake port 31 of the engine 12 to form the corresponding air-intake passage 32. A throttle shaft 33 is rotatably mounted to penetrate the air-intake tubular portions 30. Four disc-shaped throttle valves 34 are attached to the throttle shaft 33. Each throttle valve 34 is provided within the corresponding air-intake tubular portion 30 and is configured to substantially open and close the air-intake passage 32 by rotation of the throttle shaft 33. Furthermore, a fuel injector 35 (fuel injection valve) 35 is attached to an outer wall of the corresponding air-intake tubular portion 30, and is configured to inject a fuel stored in the fuel tank 11, to be specific, gasoline, into an inside of the corresponding air-intake passage 32.

The throttle shaft 33 is provided with a first gear 36 at one end portion in an axial direction thereof. The throttle valve opening and closing device 14 is attached to the throttle shaft 33 by the first gear 36. The throttle valve opening and closing device 14 has a DC motor 37, which is a drive device. The DC motor 37 has an output shaft 38 provided with a second gear 39, which is configured to mesh with the first gear 36 of the throttle shaft 33 to enable a driving force of the DC motor 37 to be transmitted to the throttle shaft 33. The DC motor 37 is electrically coupled to the ECU 22 and to a battery (not shown), which are hereinafter referred to as the ECU 22 and the like.

The throttle valve opening and closing device 14 further has a rotatable throttle pulley 40. A throttle wire W is wound around the throttle pulley 40. The throttle wire W is wound around the throttle pulley 40 and the throttle grip 41 of the steering handle 4 (FIG. 1) to couple the throttle pulley 40 and the throttle grip 41 to each other. The throttle grip 41 is rotatably attached to the steering handle 4. The throttle wire W operates in association with the rotation operation of the throttle grip 41 performed by the user to cause the throttle pulley 40 be rotated. A return spring (not shown) is mounted on the throttle pulley 40. The return spring applies a force to the throttle pulley 40 in one rotational direction, to be specific, a direction to close the throttle valve 34. Thereby, in a state where the throttle grip 41 is not hand-operated, the throttle pulley 40 causes the throttle valve 34 to be closed via the throttle wire W. A grip position sensor (hand-operation angle sensor: GPS) 42, which is an opening degree detector, is attached on the throttle pulley 40. The GPS 42 is configured to be able to detect an angular displacement amount of the throttle pulley 40 to thereby detect the opening degree of the throttle grip 41. A throttle position sensor (valve angle sensor: TPS) 40 is attached on an opposite axial end portion of the throttle shaft 33 and is configured to detect an angular displacement amount of the throttle shaft 33 to thereby detect an opening degree of the throttle valve 34. The GPS 42 and the TPS 43 are respectively electrically coupled to the ECU 22 and the like.

The engine 12 includes a cylinder block 46 having a plurality of, in this embodiment, four, cylinders 48, although one combustion chamber 45 and its associated components such as the air-intake passage 32 are illustrated and the other combustion chambers 45 and their associated components are omitted in FIG. 2. Each cylinder 48 is provided with a piston 47 configured to be reciprocatable. The reciprocation of the piston 47 causes a crankshaft (not shown) which is an output shaft of the engine 12, to rotate. The crankshaft is coupled to the rear wheel 3 via a transmission (not shown) and a chain 49 (FIG. 2). When the engine 12 rotates, the resulting driving force is transmitted to the rear wheel 3 via the transmission and the chain 49, causing the rear wheel 3 to rotate.

The cylinder block 46 is provided with a cylinder head 54. The cylinder head 54 is provided with the corresponding combustion chamber 45 connected to the cylinder 48, and the intake port 31 and the exhaust port 50, which are connected to the combustion chamber 45. As described above, each of the air-intake passages 32 is coupled to the corresponding intake port 31, and the muffler (not shown) is coupled to the exhaust ports 50. The cylinder head 54 is provided with an intake valve 51 configured to open and close the corresponding intake port 31, and an exhaust valve 51 configured to open and close the corresponding exhaust port 50, for each intake port 31 and for each exhaust port 50, respectively. The intake valve 51 opens the intake port 31 to feed to the combustion chamber 45 an air-fuel mixture of the air delivered from the air cleaner box 15 and the fuel injected from the fuel injector 35, and closes the intake port 31 when the air-fuel mixture is not fed to the combustion chamber 45. The exhaust valve 52 opens the exhaust port 50 to exhaust an exhaust gas generated by combustion and closes the exhaust port 50 when the exhaust gas is not exhausted. An ignition device 53 is provided for each combustion chamber 45 in the cylinder head 54. The ignition device 53 is, for example, an ignition plug, and is configured to be able to ignite the air-fuel mixture in the interior of the combustion chamber 45. The ignition device 53 is electrically coupled to the ECU 22 and the like.

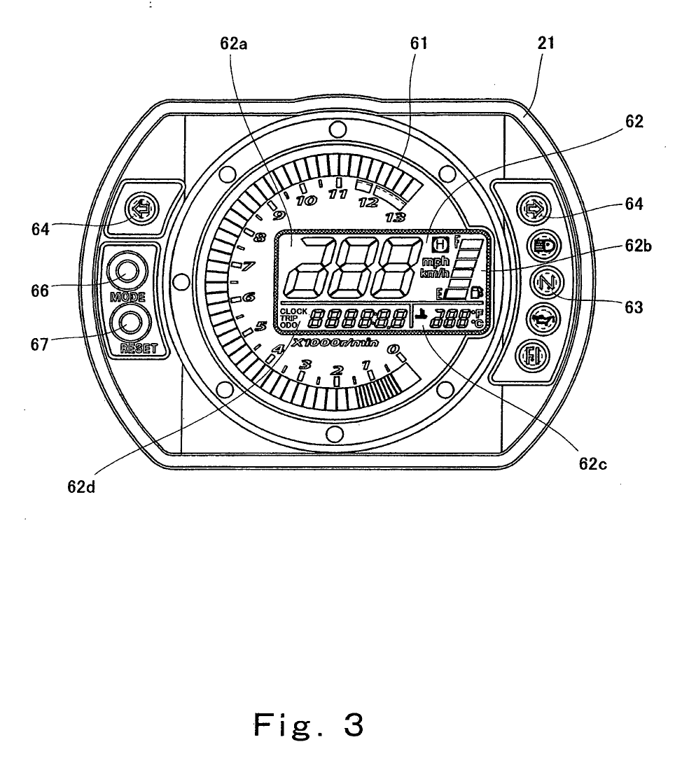

FIG. 3 is a plan view of the meter device 21. The meter device 21 includes a tachometer 61 for indicating an engine speed of the engine 12, a digital display part 62 for displaying various information such as speeds of the motorcycle 1, a neutral indicator part 63 for indicating that a gear position of the transmission is a neutral position, a direction indicator lamp 64, etc. The digital display part 62 is realized by a liquid crystal display device. The digital display part 62 includes a speed display area 62a for displaying the vehicle speed of the motorcycle 1, a fuel amount display area 62b for displaying an amount of the fuel remaining in the fuel tank 10, a water temperature display area 62c for displaying a temperature of cooling water for cooling the engine 12, a multi-function display area 62d which switches the display mode to display one of time, a travel distance (TRIP), and an accumulated travel distance (ODO), etc.

The meter device 21 is provided with a meter controller 65 (FIG. 2) configured to cause the parts 61 to 64 to display or indicate characters or figures and to control the parts 61 to 64 of the meter device 21. A mode switch 66 and a reset switch 67 are electrically coupled to the meter device 21. The mode switch 66 and the reset switch 67, which are an input device, are push-button switches. The mode switch 66 is configured to switch the display mode of the multi-function display area 62d. The reset switch 67 is configured to reset the characters and figures displayed on the multi-function display area 62d. To be specific, the reset switch 67 is configured to reset the time, and the travel distance displayed on the multi-function display area 62d. In addition, the mode switch 66 and the reset switch 67 serve as switches for increasing or decreasing a target engine speed in an idling engine speed control mode to be described later. In this embodiment, the mode switch 66 and the reset switch 67 are arranged at a left side of the meter device 21. An ignition switch 68 (FIG. 2) is attached on the upper bracket. The ignition switch 68 is electrically coupled to the ECU 22 and the like, and is configured to be able to switch between ON and OFF of electric equipment.

As shown in FIG. 2, the idling engine speed control system 20 includes an engine speed meter 69, a water temperature meter 70, and a gear position detector 71. The engine speed meter 69, which is an engine running detector, is configured to measure the engine speed of the engine 12. The water temperature meter 70, which is a temperature meter, is configured to measure the temperature of the cooling water for cooling the engine 12 to thereby detect the temperature of the engine 12. The gear position detector 71 is configured to detect the gear position of the transmission. The gear position detector 71 is, in this embodiment, realized by a shift pedal position sensor, and is configured to detect a shift position detected by the shift pedal position sensor as the gear position. Hereinafter, the gear position detector 71 is referred to as the shift pedal position sensor 71. The engine speed meter 69, the water temperature meter 70, and the shift pedal position sensor 71 are electrically coupled to the ECU 22, and the like.

The ECU 22, which is a mode controller, includes a memory 72, a CPU (central processing unit) 73, a motor drive circuit 74, and an ignition circuit 75. The memory 72, which is an engine speed memory, is configured to store a target engine speed which is a target value of the engine speed of the engine 12, and to be able to rewrite the target engine speed.

The CPU 73, which is an opening degree controller, includes a target opening degree controller 73a and an ignition timing controller 73b. The target opening degree controller 73a is configured to, according to the target engine speed stored in the memory 72, output a drive signal and to control an opening degree to which the throttle valve 34 is opened so that the engine speed of the engine 12 becomes the target engine speed. In addition, the target opening degree controller 73a is configured to feed-back control the opening degree of the throttle valve 34 based on the opening degree of the throttle valve 34 detected by the TPS 43 and the engine speed measured by the engine speed meter 69 so that the engine speed becomes the target engine speed. The ignition timing controller 73b is configured to, according to the target engine speed stored in the memory 72, output an ignition signal to control an ignition timing of the ignition device 53 so that the engine speed becomes the target engine speed. In addition, the ignition timing controller 73b is configured to feed-back control the ignition timing based on the engine speed measured by the engine speed meter 69 so that the engine speed becomes the target engine speed. The target opening degree controller 73a and the ignition timing controller 73b are configured to feed-back control based on, for example, an average value of the engine speeds measured by the engine speed meter 69 in a predetermined time period. But, the average value of the engine speeds in the predetermined time period is merely exemplary.

The motor drive circuit 74 is configured to drive the DC motor 37 based on the drive signal output from the CPU 73, to be precise, from the target opening degree controller 73a. The ignition circuit 75 is configured to drive the ignition device 53 based on an ignition signal output from the CPU 73, to be precise, from the ignition timing controller 73b.

In the motorcycle 1 configured as described above, when the user rotates the throttle grip 41 in a direction to open the throttle valve 34, the throttle pulley 40 rotates in association with the rotation of the throttle grip 41. The GPS 42 is configured to detect a rotation amount of the throttle pulley 40, i.e., an opening degree of the throttle grip 41, and to send it to the ECU 22. The ECU 22 is configured to calculate an opening degree of the throttle valve 34 according to the opening degree sent from the GPS 42. The ECU 22 causes the motor drive circuit 74 to drive the DC motor 37 to control the opening degree of the throttle valve 34 so that the opening degree of the throttle valve 34 becomes the opening degree obtained by calculation. Furthermore, the ECU 22 is configured to execute feedback control based on an opening degree amount of the throttle valve 34 sent from the TPS 43 so that the opening degree of the throttle valve 34 becomes the opening degree obtained by calculation. The ECU 22 controls the opening degree of the throttle valve 34 to control the flow rate of the air supplied to the engine 12, controls an amount of the fuel injected from the fuel injector 35, and controls the ignition timing of the ignition device 53, thereby controlling the engine speed of the engine 12.

The ECU 22 is configured to control the opening degree of the throttle valve 34 and to supply the air and the fuel to the engine 12 so that the idling state is maintained, in the case where the opening degree of the throttle grip 41 is not more than a reference value for determining whether or not the throttle grip 41 is in a closed state. As used herein, the reference value for determining whether or not the throttle grip 41 is in the closed state, is a predetermined value, and is zero in this embodiment. The predetermined value may be a value larger than zero.

A control process executed by the ECU 22 when the reference value is zero will now be described. In the idling state, the ECU 22 is configured to control the opening degree of the throttle valve 34 and the ignition timing of the ignition device 53 so that the engine 12 is driven according to the target engine speed stored in the memory 72. The target engine speed in the idling state is rewritable by a user, and therefore is changeable according to the user's taste or preference, etc. How the engine speed in the idling state is changed will now be described.

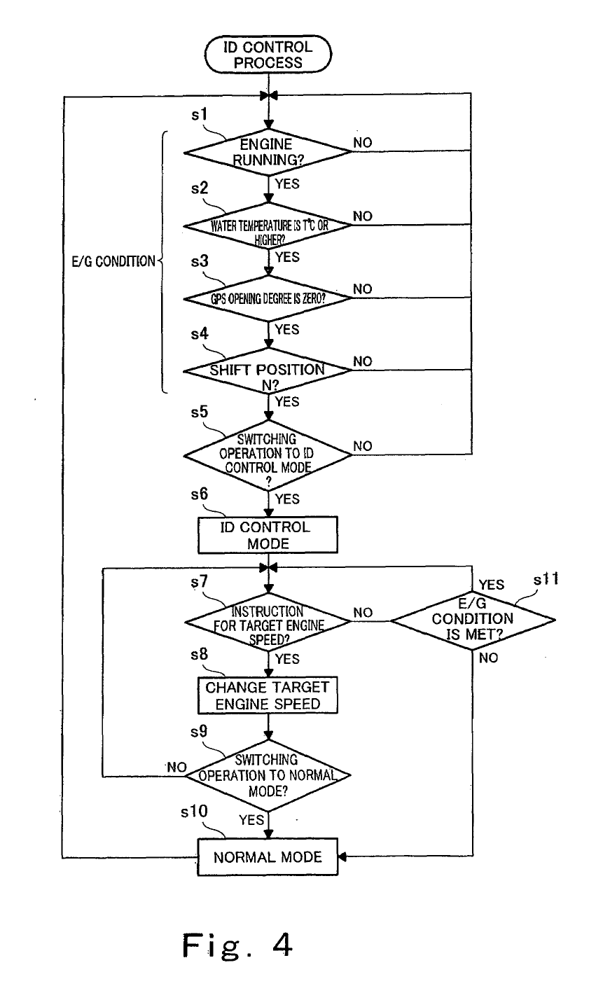

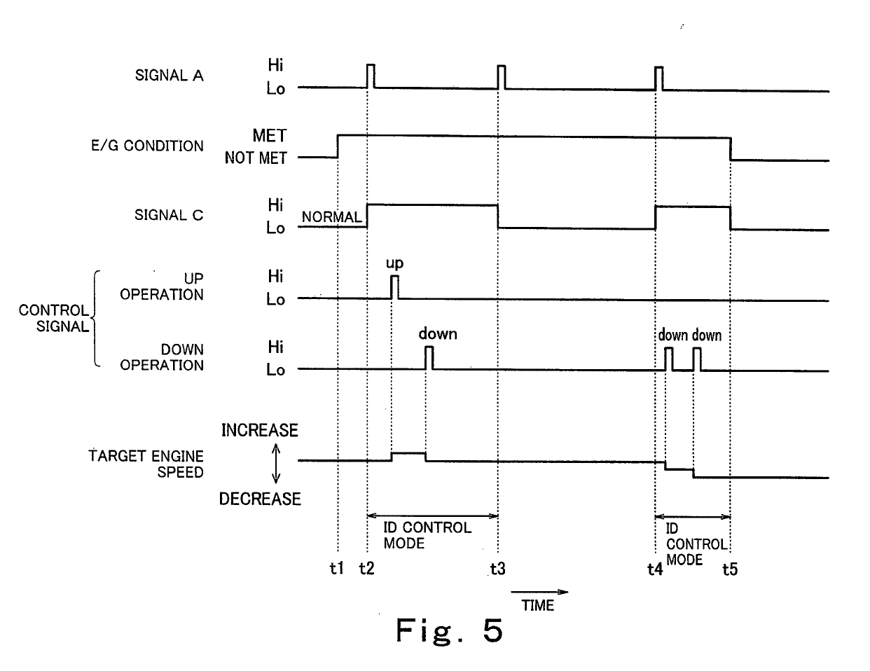

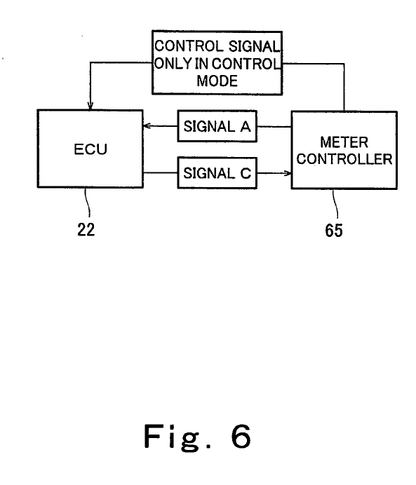

FIG. 4 is a flowchart showing the idling control process for changing the engine speed in the idling state. FIG. 5 is a view showing a time-lapse change of a signal transmitted between the ECU 22 and the meter controller 65. FIG. 6 is a block diagram showing transmission of the signal between the ECU 22 and the meter controller 65. In FIG. 5, a horizontal axis indicates time, and a vertical axis indicates high (Hi) and low (Lo) levels of the signal, whether an engine condition is met or not met, and the increase or decrease in a value of the target engine speed.

Turning to FIG. 4, when the ignition switch 68 is tuned ON, the idling control process is started and step s1 is performed, in which the ECU 22 determines whether or not the engine 12 is running, based on the signal from the engine speed meter 69. If it is determined that the engine 12 is not running (NO in step s1), the ECU 22 continues to determine whether or not the engine 12 is running until the engine. 12 starts running. If it is determined that the engine 12 is running (YES in step s1), the ECU 22 advances the process to step s2.

In step s2, the ECU 22 determines whether or not the temperature of the cooling water for cooling the engine 12 is a predetermined value T or higher, based on water temperature measured by the water temperature meter 70. The predetermined value T is, for example, not lower than 50° C. and not higher than 90° C., and preferably, 70° C., which ranges are merely exemplary. If it is determined that the water temperature is lower than the predetermined value T (NO in step s2), the ECU 22 returns the process to step s1. On the other hand, if it is determined that the water temperature is the predetermined value T or higher (YES in step s2), the ECU 22 advances the process to step s3.

In step s3, the ECU 22 determines whether or not the opening degree of the throttle grip 41 is not more than the predetermined reference value for determining whether or not the throttle grip 41 is in the closed state. To be more specific, the ECU 22 determines whether or not the opening degree of the throttle grip 41 is zero, based on the opening degree of the throttle grip 41 sent from the GPS 42. If it is determined that the opening degree of the throttle grip 41 is not zero (NO in step s3), the ECU 22 returns the process to step s1. On the other hand, if it is determined that the opening degree of the throttle grip 41 is zero (YES in step s3), the ECU 22 advances the process to step s4.

In step s4, the ECU 22 determines whether or not the gear position is a neutral position (N). The ECU 22 determines whether or not the gear position is the neutral position N, based on the shift position sent from the shift pedal position sensor 71. If it is determined that the gear position is not the neutral position N (NO in step s4), the ECU 22 returns the process to s1, whereas if it is determined that the gear position is the neutral position N (YES in step s4), the ECU 22 advances the process to step s5.

The above conditions used in steps s1 through s4, to be specific, whether or not the engine 12 is running, whether the water temperature of the cooling water is the predetermined value T or higher, whether the opening degree of the throttle grip 41 is zero, and whether the gear position is the neutral position N, are hereinafter collectively referred to as an engine condition. If it is determined that all the conditions included in the engine condition are met, then it is determined that the engine condition is met, whereas if it is determined that at least one of these conditions is not met, then it is determined that the engine condition is not met (see time t1 in FIG. 5).

In step s5, the ECU 22 determines whether or not a switching operation has been executed. The switching operation means an operation to switch between an idling engine speed control mode (hereinafter referred to as an ID control mode) in which the target engine speed can be input with the input device, and a normal mode in which the target engine speed cannot be input with the input device. In this embodiment, the switching operation is to press the mode switch 66 and the reset switch 66 substantially at the same time and to continue to press them for a predetermined time period. The meter controller 65 determines whether or not the switching operation has been executed. If it is determined that the switching operation has been executed, the meter controller 65 sends a signal A (FIG. 6) to the ECU 22, indicating that the switching operation has been executed. The ECU 22 receives the signal A and determines that the switching operation has been executed, based on the received signal A (see time t1 in FIG. 5 and signal A in FIG. 6), and advances the process to step s6.

In step s6, the ECU 22 sends a signal C (FIG. 6) to the meter controller 65 to instruct the meter controller 65 to change the mode (see signal C in FIG. 6). The ECU 22 switches the signal C to be sent to the meter controller 65 from Lo to Hi, so that the meter controller 65 changes the mode (time t2 and time t4 in FIG. 5). To be specific, the ECU 22 causes the meter controller 65 to switch from the normal mode to the ID control mode. In the ID control mode, when one of the mode switch 66 and the reset switch 67 is operated, the meter controller 65 outputs to the ECU 22, a control signal for increasing the engine speed of the engine 12 in the idling state (hereinafter referred to as an idling engine speed), i.e., a control signal for increasing the target engine speed, while when the other of the mode switch 66 and the reset switch 67 is operated, the meter controller 65 outputs to the ECU 22, a control signal for decreasing the idling engine speed, i.e., a control signal (see FIG. 6) for decreasing the target engine speed, as illustrated by the control signals of FIGS. 5 and 6. In this embodiment, the mode switch 66 is operated once (one notch) so that the target engine speed stored in the memory 72 is increased by, for example, 25 rpm, or the reset switch 67 is operated once so that the target engine speed stored in the memory 72 is decreased by, for example, 25 rpm. The numeric value 25 rpm is merely exemplary and other suitable values may be used. Entering the ID control mode, the ECU 22 advances the process to step s7.

In step s7, the ECU 22 determines whether or not there is an instruction for changing the target engine speed. When the mode switch 66 or the reset switch 67 has been operated, the meter controller 65 sends to the ECU 22 the control signal for increasing or decreasing the target engine speed. For example, as shown in FIG. 5, in the ID control mode, when the mode switch 66 is operated, the meter controller 65 sends to the ECU 22 a control signal indicating “up (increase),” whereas when the reset switch 67 is operated, the meter controller 65 sends to the ECU 22 a control signal indicating “down (decrease).” Receiving the control signal, the ECU 22 determines that there is the instruction for changing the target engine speed, and advances the process to step s8.

In step s8, the ECU 22 changes the target engine speed stored in the memory 72. Based on the control signal received in step s7, the ECU 22 increases or decreases the target engine speed stored in the memory 72. To be more specific, as shown in FIG. 5, the ECU 22 increases the target engine speed stored in the memory 72 receiving the control signal “up (increase),” or decreases the target engine speed stored in the memory 72 receiving the control signal “down (decrease).” Furthermore, based on the target engine speed changed in this way, the CPU 73 controls the opening degree of the throttle valve 34 and the ignition timing of the ignition device 53 so that the idling engine speed reaches the target engine speed. In this manner, the idling engine speed is controlled to reach the target engine speed. Then, the ECU 22 advances the process to step s9.

In step s9, the ECU 22 determines whether or not the switching operation has been executed. The meter controller 65 determines whether or not the switching operation has been executed. If it is determined that the switching operation has not been executed (NO in step s9), the meter controller 65 does not send the signal A to the ECU 22, and the ECU 22 returns the process to step s7. On the other hand, if it is determined that the switching operation has been executed (YES in step s9), the meter controller 65 sends the signal A to the ECU 22. Receiving the signal A, the ECU 22 determines that the switching operation has been executed (see time t3 in FIG. 5), and advances the process to step s10.

In step s10, the ECU 22 switches the signal C to be sent to instruct the meter controller 65 to change the mode (see signal C in FIG. 6). The ECU 22 switches the signal C sent to the meter controller 65 from Hi to Lo. Receiving the signal C that is Lo, the meter controller 65 changes the ID control mode to the normal mode (time t3 in FIG. 5). In the normal mode, the target engine speed is unable to be changed by operating the mode switch 66 or the reset switch 67. In the normal mode, as described above, the mode switch 66 is configured to switch the modes of clock, TRIP, ODO, and the like, and the reset switch 67 is configured to reset the figures and characters of clock and TRIP. Entering the normal mode, the ECU 22 returns the process to step s1.

If it is determined that the switching operation has not been executed in step s5 (NO in step s5), the meter controller 65 does not send the signal A to the ECU 22, and therefore, the ECU 22 determines that the switching operation has not been executed, and returns the process to step s1.

If it is determined that the mode switch 66 and the reset switch 67 have not been operated in step s7 (No in step s7), the meter controller 65 does not send the ECU 22 the control signal, and therefore, the ECU 22 determines that there is no instruction for changing the target engine speed, and advances the process to step s11.

In step s11, the ECU 22 determines whether or not the engine condition is met. The ECU 22 determines whether or not all the conditions included in the engine condition are met. If it is determined that all the conditions are met (YES in step s11), the ECU 22 returns the process to step s7, whereas if it is determined that all the conditions are not met (NO in step s11), the ECU 22 advances the process to step s10 to change the mode (see time t5 in FIG. 5).

Hereinafter, advantages achieved by the idling engine speed control system 20 of this embodiment will be described. In accordance with the idling engine speed control system 20, the user is able to easily change the idling engine speed by merely inputting the target engine speed with the mode switch 66 or the reset switch 67 attached to the motorcycle 1 according to the user's taste or preference, use of the motorcycle 1, etc..

In accordance with the idling engine speed control system 20 of this embodiment, the ECU 22 is configured to switch the ID control mode to the normal mode in which the target engine speed is unable to be input, to avoid unexpected change of the idling engine speed in the normal mode upon the switching operation being executed in the ID control mode. This makes it possible to inhibit the idling engine speed from being changed against the user's will. As a result, the idling engine speed changed according to the user's taste or preference, the use of the motorcycle 1, etc., can be maintained.

In accordance with the idling engine speed control system 20 of this embodiment, since the mode switch 66 and the reset switch 67 are provided at the meter device 21 for displaying the engine speed of the engine 12, the user is able to input the target engine speed with the mode switch 66 or the reset switch 67 to control the idling engine speed, while checking the tachometer 61. This enables the user to control the idling engine speed with the mode switch 66 or the reset switch 67 while watching the engine speed, in addition to hearing an engine noise, a gas exhausting noise, etc. Thus, the user is able to easily set the idling engine speed according to the user's taste or preference, the use of the motorcycle 1, etc.

In accordance with the idling engine speed control system 20 of this embodiment, if the user executes the switching operation in the normal mode only when the temperature of the engine 12 is the predetermined value or higher, that is, except for a case where the temperature of the engine 12 is lower than the predetermined value, the normal mode switches to the ID control mode. In other words, when the water temperature of the cooling water is lower than the predetermined temperature T, switching to the ID control mode is unable to be executed. This makes it possible to inhibit the idling engine speed from being changed in the state where the water temperature of the cooling water is lower than the predetermined temperature T, for example, in an overly cooled state. To meet exhaust gas regulation, it is necessary to decide a lowest engine speed of the engine speed 12 in the idling state under low temperature conditions. By inhibiting switching to the ID mode in the idling state when the water temperature of the cooling water is lower than the predetermined value T as described above, the idling engine speed can be maintained at the lowest engine speed or higher under the low temperature conditions.

In accordance with the idling engine speed control system 20 of this embodiment, if the user executes the switching operation in the normal mode only when the opening degree of the throttle grip 41 is not more than the predetermined reference value used for determining whether or not the throttle grip 41 is in the closed state, the normal mode switches to the ID control mode. That is, switching to the ID mode is unable to be executed unless the opening degree of the throttle grip 41 is not more than the predetermined reference value. This makes it possible to inhibit the idling engine speed from being changed in the state where the throttle grip 41 is in an open state beyond the predetermined reference value, for example, to open the air-intake passage 32 to a large extent so that the engine speed is increased. If the target engine speed is decreased in the state where the throttle grip 41 is in the open state and the opening degree of the throttle grip 41 is returned to the predetermined reference value or less, the corresponding engine speed, i.e., the engine speed in the idling state becomes low, causing the engine 12 to stop. Such a situation can be avoided by inhibiting the idling engine speed from being changed in the state where the opening degree of the throttle grip 41 is not zero.

In accordance with the idling engine speed control system 20 of this embodiment, if the user executes the switching operation in the normal mode only when the gear position is the neutral position, the normal mode switches to the ID control mode. That is, switching to the ID control mode is unable to be executed in the state where the gear position is in a position other than the neutral position N. This makes it possible to inhibit the idling engine speed being changed by inputting the target engine speed by the user while the motorcycle 1 is traveling, for example. In the motorcycle 1 equipped with the electronic throttle valve (ETV), the opening degree of the throttle valve 34 is controlled based on the opening degree of the throttle grip 41, using the opening degree of the throttle valve 34 in the idling state as the reference. If the user changes the idling engine speed during the travel of the motorcycle 1, the throttle valve 34 is opened or closed excessively. Such a situation can be avoided by inhibiting switching to the ID control mode in the state where the gear position is in a position other than the neutral position N.

In accordance with the idling engine speed control system 20 of this embodiment, if the user executes the switching operation in the normal mode only when the engine 12 is running, the normal mode switches to the ID control mode. That is, switching to the ID mode is unable to be executed when the engine 12 is in a stopped state. This makes it possible to inhibit the idling engine speed from being changed to an undesired value such as a too high or low value when the engine 12 is in the stopped state, at the start of the engine 12.

If the user executes the switching operation in the normal mode only when the first to fourth conditions are all met, the normal mode switches to the ID control mode. In other words, if one of the first to fourth conditions is not met, the user is unable to switch the normal mode to the ID control mode. This makes it possible to inhibit the target engine speed from being changed in cases where the engine 12 is in an overly cooled state, the air-intake passage 32 is open to a large degree so as to increase the engine speed, the gear position is other than the neutral position N, or the engine 12 is in the stopped state.

In accordance with the idling engine speed control system 20 of this embodiment, the mode switch 66 for switching the display modes of the display area 62d and the reset switch 67 for resetting the characters and figures displayed on the display area 62d are used for switching between the normal mode and the ID control mode, and for increasing and decreasing the target engine speed in the ID control mode. As a result, the number of components can be reduced, and the configuration of the idling engine speed control system 20 can be simplified.

The motorcycle 1 equipped with the idling engine speed control system 20 of this embodiment, is able to control its idling engine speed.

Whereas in this embodiment, the engine condition includes the above identified four conditions, it may alternatively include one to three of the four conditions, and the normal mode is able to switch to the ID control mode if all of these conditions are all met. Alternatively, in a part of ranges defined in the four engine conditions, in which switching to the ID control mode is basically inhibited, a range for permitting switching to the ID control mode may be set exceptionally.

For example, the engine condition may omit whether or not the engine 12 is running, but may include the water temperature, the opening degree of the throttle grip 41, and the shift position. In this case, the user is likely to change the target engine speed although the engine 12 is in the stopped state and the user does not hear the noise of the engine 12. To avoid this, the target engine speed may be displayed on the meter device 21 or the like to enable the user to control the idling engine speed while watching the target engine speed displayed thereon. Furthermore, the idling engine speed control system 20 may be configured so that in the ID control mode, the target engine speed is returned to a predetermined engine speed by turning off the ignition switch 68, or the target engine speed resulting from turning off the ignition switch 68 is stored in the memory 72.

Furthermore, one or more other conditions may be added to the above four conditions, or may replace any one of the above four conditions. The one or more other conditions may include that the vehicle speed is zero (or the vehicle speed is not higher than a stop determination speed for determining whether or not the vehicle is in the stopped state). In this case, the ECU 22 is configured to detect the vehicle speed based on a signal from vehicle speed sensor (vehicle speed detector) 77 (FIG. 2 ) attached on the motorcycle 1, and to determine whether or not the vehicle speed is the predetermined stop determination speed or lower based on the detected vehicle speed. The stop determination speed is, in this embodiment, 0 km per hour.

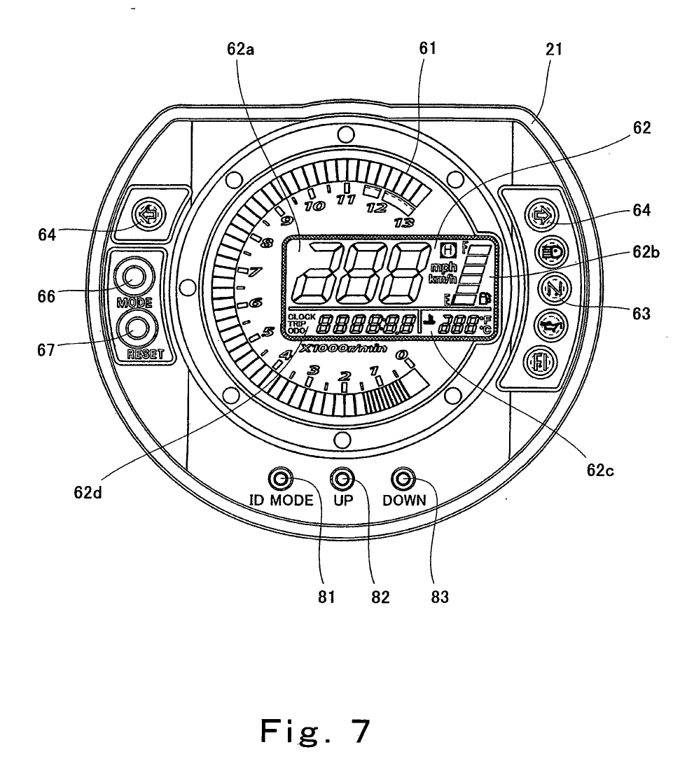

In such a configuration, if the user executes the switching operation only when the vehicle speed is not higher than the predetermined stop determination speed, the normal mode switches to the ID control mode. That is, if the vehicle speed exceeds the predetermined stop determination speed, the user is unable to switch the normal mode to the ID control mode. It should be noted that 0 km of the predetermined stop determination speed is merely exemplary. This makes it possible to inhibit the idling engine speed from being changed to an undesired value such as a too high or low engine value while the user is driving the motorcycle 1.

Whereas in this embodiment, the ECU 22 makes determination based on the engine condition, in the order of running of the engine 12, the water temperature, the opening degree of the throttle grip 41, and the shift position, it may alternatively make determination in another suitable order. If the engine condition is not met in the middle of the ID control mode, then the target engine speed changed last before the condition is met is stored in the memory 72. Instead, the target engine speed stored in the memory 72 may be returned to the target engine speed before switching to the ID control mode.

Whereas in this embodiment, the opening degree of the throttle valve 34 is controlled to control the idling engine speed, such a configuration is merely exemplary. For example, a bypass passage may be formed in the air-intake passage 32 to be connected to a region of the air-intake passage 32 which is located upstream of the throttle valve 34 and a region thereof which is located downstream of the throttle valve 34, and a valve may be provided within the bypass passage to substantially open and close the bypass passage. In this case, in the idling state, the ECU 22 may be configured to control the opening degree of the valve according to the target engine speed to control the flow rate of the air so that the idling engine speed becomes the target engine speed.

Whereas in this embodiment, the target engine speed is input with the mode switch 66 or the reset switch 67, a volume switching may be carried out using a variable resistance to execute stepwise or stepless control. In addition, instead of the switch with which the target engine speed is input in one-notch manner, the input device may be a key board with which a numeric value indicating the target engine speed is input, so long as the target engine speed can be input with the input device. Furthermore, the input device need not be mounted to the motorcycle 1, but may be an external device such as a personal computer. Moreover, the target engine speed may be configured to be displayed on the meter device 21, or the like. This makes it easy to set the target engine speed according to the user's taste or preference, the use of the motorcycle 1, etc.

Whereas in this embodiment, the switching operation is executed by pressing the mode switch 66 and the reset switch 67 at the same time, either the mode switch 66 or the reset switch 67 may be pressed for a long time period. FIG. 7 is a view showing another embodiment of the meter device 21A. As shown in FIG. 7, the meter device 21A is provided with an ID mode switch 81 which is independent of the mode switch 66 and the reset switch 67 and is configured to be pressed to execute the switching operation. The meter device. 21A is further provided with an UP switch 82 and a DOWN switch 83. When the UP switch 82 or the DOWN switch 83 is operated, the target engine speed controller 20 is configured to increase and decrease the target engine speed. Whereas the increase and decrease in the target engine speed are detected based on the rising of the control signal as shown in FIG. 5, they may alternatively be detected based on the falling of the control signal.

The throttle wire W may be omitted in the idling engine speed control system 20 equipped in the motorcycle 1. For example, the idling engine speed control system 20 may be configured so that the GPS 42 is directly attached on the throttle grip 41 to detect the opening degree of the throttle grip 41.

Whereas in this embodiment, the idling engine speed control system 20 is applied to the motorcycle 1, it may alternatively be applied to other vehicles equipped with engines, such as all terrain vehicles (ATVs), or automobiles. Furthermore, the throttle grip 41 may be a throttle pedal.

Whereas in this embodiment, the motorcycle 1 is water-cooled, the present invention may be applied to air-cooled motorcycles. In this case, the temperature of the engine is measured by a cylinder wall temperature sensor.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An idling engine speed control system for a vehicle comprising:
a valve which is provided within an air-intake passage connected to an engine mounted in the vehicle and is configured to substantially open and close the air-intake passage;
a drive device configured to open and close the valve;
an opening degree controller configured to drive the drive device, the opening degree controller being configured to control an opening degree of the air-intake passage;
an input device which is attached to the vehicle and is configured to input a target engine speed in an idling state; and
an engine speed memory configured to store the target engine speed input with the input device;
wherein the opening degree controller is configured to control the opening degree of the air-intake passage in the idling state according to the target engine speed stored in the engine speed memory.

2. The idling engine speed control system according to claim 1, further comprising:
a mode controller configured to execute switching between an idling engine speed control mode in which the target engine speed is able to be input with the input device and a normal mode in which the target engine speed is unable to be input with the input device;
wherein the input device is configured to execute a switching operation for switching between the idling engine speed control mode and the normal mode; and
wherein the mode controller is configured to execute switching between the idling engine speed control mode and the normal mode based on the switching operation executed by the input device.

3. The idling engine speed control system according to claim 1,
wherein the input device is attached to a meter device which is mounted to the vehicle and is configured to display an engine speed of the engine.

4. The idling engine speed control system according to claim 2, further comprising:
a temperature meter configured to measure a temperature of the engine;
wherein the mode controller is configured to enable switching to the idling engine speed control mode based on the switching operation when the temperature of the engine which is measured by the temperature meter is a predetermined value or higher.

5. The idling engine speed control system according to claim 2, further comprising:
an opening degree detector configured to detect an opening degree of a throttle grip mounted to the vehicle;
wherein the mode controller is configured to enable switching to the idling engine speed control mode based on the switching operation, when the opening degree detected by the opening degree detector is not more than a predetermined reference value used for determining whether or not the throttle grip is in a closed state.

6. The idling engine speed control system according to claim 2, further comprising:
a gear position detector configured to detect a gear position of a transmission disposed between an output shaft of the engine and a wheel of the vehicle;
wherein the mode controller is configured to enable switching to the idling engine speed control mode based on the switching operation, when the gear position detected by the gear position detector is a neutral position.

7. The idling engine speed control system according to claim 2, further comprising:
an engine running detector configured to detect whether or not the engine is running;
wherein the mode controller is configured to enable switching to the idling engine speed control mode based on the switching operation, when the engine running detector has detected that the engine is running.

8. The idling engine speed control system according to claim 2, further comprising:
a vehicle speed detector configured to detect a vehicle speed of the vehicle;
wherein the mode controller is configured to enable switching to the idling engine speed control mode based on the switching operation when the vehicle speed detected by the vehicle speed detector is not higher than a predetermined value used for determining whether or not the vehicle is in a stopped state.

9. The idling engine speed control system according to claim 2,
wherein the input device has two push-button switches, and is configured to increase the target engine speed stored in the engine speed memory by a predetermined value each time one of the push-button switches is pressed and to decrease the target engine speed stored in the engine speed memory by a predetermined value each time the other of the push-button switches is pressed; and
wherein the two push-button switches may be configured to enable the switching operation for pressing the two push-button switches substantially at the same time.

10. The idling engine speed control system according to claim 2,
wherein the input device has first to third push-button switches;
wherein the first switch is configured to enable the switching operation;
wherein the second switch is configured to increase the target engine speed stored in the engine speed memory by a predetermined value each time the second switch is pressed; and
wherein the third switch is configured to decrease the target engine speed stored in the engine speed memory by a predetermined value each time the third switch is pressed.

11. The idling engine speed control system according to claim 1,
wherein the opening degree controller is configured, when the target engine speed is input with the input device to change the target engine speed in the idling state of the engine, to control the opening degree of the air-intake passage in the idling state according to the changed target engine speed.

12. The idling engine speed control system according to claim 1, further comprising:
an engine speed meter configured to measure an engine speed of the engine;
wherein the opening degree controller is configured to, based on an engine speed of the engine in the idling state which is measured by the engine speed meter, control the opening degree of the air-intake passage in the idling state so that the engine speed in the idling state conforms to the target engine speed.

13. The idling engine speed control system according to claim 2, further comprising:
a mode controller configured to switch an idling engine speed control mode in which the target engine speed is able to be input with the input device and a normal mode in which the target engine speed is unable to be input with the input device;
an engine running detector configured to detect whether or not the engine is running;
a temperature meter configured to measure a temperature of the engine;
an opening degree detector configured to detect an opening degree of the throttle grip; and
a gear position detector configured to detect a gear position of a transmission disposed between an output shaft of the engine and a wheel of the vehicle;
wherein the input device is configured to enable a switching operation for switching between the idling engine speed control mode and the normal mode;
and wherein the mode controller is configured to enable switching to the idling engine speed control mode based on the switching operation, when a first condition in which the temperature measured by the temperature meter is a predetermined temperature or higher, a second condition in which the opening degree detected by the opening degree detector is not more than a predetermined reference value used for determining whether or not the throttle grip is in a closed state, a third condition in which the gear position detected by the gear position detector is a neutral position, and a fourth condition in which the engine running detector detects that the engine is running are all met.

14. The idling engine speed control system according to claim 1, further comprising:
an ignition device configured to ignite an air-fuel mixture in a combustion chamber of the engine;
wherein the opening degree controller is configured to control an ignition timing of the ignition device in the idling state according to the target engine speed.

15. The idling engine speed control system according to claim 1, further comprising:
an fuel injector configured to inject a fuel to inside of the air-intake passage;
wherein the opening degree controller is configured to control an amount of the fuel injected from the fuel injector in the idling state according to the target engine speed.

16. An idling engine speed control system for a vehicle, comprising:
a valve which is provided within an air-intake passage connected to an engine mounted in the vehicle and is configured to substantially open and close the air-intake passage;
a drive device configured to open and close the valve;
an ignition device configured to ignite an air-fuel mixture in a combustion chamber of the engine;
an fuel injector configured to inject a fuel to inside of the air-intake passage;
an opening degree controller configured to drive the drive device to control an opening degree of the air-intake passage and to control an ignition timing of the ignition device and an amount of the fuel injected from the fuel injector;
an input device which is attached to the vehicle and is configured to receive a target engine speed input in an idling state to change the target engine speed; and
an engine speed memory configured to store the target engine speed input with the input device;
wherein the opening degree controller is configured to control the opening degree of the air-intake passage, the ignition timing and the amount of the fuel injected from the fuel injector in the idling state, according to the target engine speed stored in the engine speed memory.

17. A vehicle comprising an idling engine speed control system, the idling engine speed control system including:
a valve which is provided within an air-intake passage connected to an engine mounted in the vehicle and is configured to substantially open and close the air-intake passage;
a drive device configured to open and close the valve;
an opening degree controller configured to drive the drive device and is configured to control an opening degree of the air-intake passage;
an input device which is attached to the vehicle and is configured to input a target engine speed in an idling state; and
an engine speed memory configured to store the target engine speed input with the input device;
wherein the opening degree controller is configured to control the opening degree of the air-intake passage in the idling state according to the target engine speed stored in the engine speed memory.
